(19) United States
(12) Patent Application Publication
(10) Pub. No.: US 2022/0022593 A1
(43) Pub. Date: Jan. 27, 2022

(54) INTEGRATED PLASTIC SHELL SKATE

(71) Applicant: Feng Jiang, Qinhuangdao City (CN)

(72) Inventor: Feng Jiang, Qinhuangdao City (CN)

(21) Appl. No.: 17/218,208

(22) Filed: Mar. 31, 2021

(51) Int. Cl. A43B 5/16; A63C 1/00; A63C 17/22; A63C 1/42

(52) U.S. Cl. CPC A43B 5/1683; A63C 1/42; A63C 17/22; A63C 1/00

(57) ABSTRACT

An integrated plastic shell skate is provided, including ice skates and roller skates, which includes a shoe inner sleeve, a plastic shoe shell and a shoe rack assembly, the shoe rack assembly is fixedly installed at the bottom of the plastic shoe shell, the shoe inner sleeve is formed by pressing once in the inner sleeve cold pressing die after pre-heating, and the plastic shoe shell is formed on the outer side of the shoe inner sleeve through the shoe shell mold, so that the plastic shoe shell and the shoe inner sleeve are integrated formed as a whole. The present disclosure has the characteristics of portability, comfort, safety, environmental protection, firmness and durability.

### CROSS REFERENCE TO RELATED DISCLOSURE

This disclosure claims priority benefit of Chinese Patent disclosure No. CN202010729381.2, filed on Jul. 27, 2020, and the entire contents of which are incorporated herein by reference.

### TECHNICAL FIELD

The present disclosure relates to the technical field of ice skates and roller skates, in particular to an integrated plastic shell skate.

### BACKGROUND

Skates include ice skates and roller skates, which are worn when skating or roller skating. The existing skate shoe is a shoe with an ice skate blade or a roller component on the sole of the skate shoe. It is not only a kind of competition equipment for sports events, but also a kind of shoes widely used in leisure sports.

The traditional manufacturing process of ice skates and roller skates is that only the part of plastic shoe shell is formed on the mold during the injection molding, but not the inner sleeve of shoes. The production process of the inner sleeve of shoes is very complex. It needs to be cut into different pieces, then scribing and hemming, and finally stitching and sewing by sewing machine. Because the inside of the shoe is curved surface, the operation of the sewing machine is difficult, and the problems such as skipping stitch, uneven line spacing and asymmetric inside and outside are easy to occur. In the process of stitching the piece, the phenomenon of dislocation and fold is also easy to occur. For different thickness and hardness of shoe inner sleeve, the traditional method is to cut cardboard as positioning reference to scribe lines, and then to connect the shell and shoe inner sleeve by using sewing machine patch and brushing glue patch. In the process of molding, the applied glue is often inaccurate and not direct to the middle line by the worker, causing distortion, and the glue used is harmful to human health.

It can be seen that the existing production process of skates is not only cumbersome, low quality, inefficiency, high production cost and difficult to connect accurately, but also pollutes the environment, which is not conducive to the health of employees and ecological environment protection.

### SUMMARY

The objective of the present disclosure is to provide an integrated plastic shell skate to solve the problems raised in the above background technology.

To achieve the above objective, the present disclosure provides the following technical solution:

An integrated plastic shell skate, including a shoe inner sleeve, a plastic shoe shell and a shoe rack assembly. The shoe rack assembly is fixedly installed at the bottom of the plastic shoe shell. The shoe inner sleeve is one-step formed by pressing once in the inner sleeve mold, and the plastic shoe shell is one-step formed by injecting once at the outer side of the shoe inner sleeve through the shoe shell mold, so that the plastic shoe shell and the shoe inner sleeve are integrated formed as a whole. The manufacturing process is as follows: the shoe inner sleeve is put on the inner mold cavity of the shoe shell mold after the forming of the shoe inner sleeve is completed; the plastic shoe shell is one-step formed on the outer side of the shoe inner sleeve by the injection molding of the shoe shell mold, so that an inner surface of the plastic shoe shell and the outer surface of the shoe inner sleeve are closely combined and integrated into a whole. In this way, the plastic shoe shell is directly formed on the outer side of the shoe inner sleeve in the shoe shell mold, and the connection between the two is more reliable. The steps of lap joint of leather fabric, manual sewing, glue brushing and glue pasting are omitted, so that the weight of the shoe is lighter, the shoe fits the foot surface more, the cost is reduced, which is environmental friendly.

According to the different requirements of plastic shell skate for the shoe inner sleeve, EVA or other high temperature resistant elastic materials with two or more hardness are selected for the shoe inner sleeve. Preferably, the shoe inner sleeve is formed by pre-heating of the cut-piece composite material, and then cold pressing into the shape and size of the shoe inner sleeve in the inner sleeve cold pressing die, which includes an inner layer, an intermediate layer and an outer layer, and the intermediate layer is made of EVA or elastic material with a certain elasticity.

In order to ensure the accurate positioning of the shoe inner sleeve in the plastic shell in the injection molding process, preferably, the shoe inner sleeve is provided with a positioning structure matched with the inner mold cavity of the shoe shell mold, the positioning structure is an eyelet of the shoe inner sleeve, and the shoe shell mold is provided with a small cylinder correspondingly, and the eyelet is sleeved and hung on the small cylinder. Convex and concave parts of the shoe inner sleeve covered from the rear end of the ankle heel part to the front end of the instep are matched with the inner mold cavity of the shoe shell mold to form an inverted buckle, and the shoe inner sleeve is buckled by the inverted buckle and the motion of the shoe inner sleeve is limited. Here, the shoe inner sleeve has a certain elasticity, and the matching design of the eyelet and the shoe shell mold for anti-displacement can effectively ensure that the shoe inner sleeve is not displaced. In addition, the matching inverted buckle clamps the shoe inner sleeve on the inner mold cavity of the shoe shell mold, preventing the shoe inner sleeve from sliding out and loosening.

Due to the physiological structure of the foot and the requirements of human movement on the shoe inner sleeve, the requirements of thickness and softness of different parts of the shoe are different, and the shoe edge part of the shoe inner sleeve is not supported by the plastic shoe shell. It is preferred that the outer side of the shoe edge part of the shoe inner sleeve is made of hard EVA material, and the outer side of the shoe edge part can also use EVA like material with high hardness, and the inner foot sticking part is made of soft EVA material. The inner foot sticking part is made of soft EVA like material, so that the shoes will not make the foot uncomfortable. Because the ankle part is movable, the shoe inner sleeve in this place should be thicker and softer than other parts, and other places adopt corresponding thickness according to different requirements of feet. Because the raw materials of the shoe inner sleeve are of the same thickness before being pressed by the cold pressing die, the hardness and softness of the shoe inner sleeve will also change when it is pressed to different thicknesses, where the feet need to be wrapped better, the thickness will be thinner. The common shoe inner sleeve is manually overlapped stitching and pasted, which can not accurately achieve the different effect of different position requirements, the thickness and hardness are not designed according to the requirements of materials and movement process, and there are often folds in the shoe inner sleeve, and the lap surface is not smooth. Here, the inner mold for making the shoe inner sleeve is made by 3D design process according to the needs of different thickness and hardness of different parts in the shoe.

In order to improve the comfort of the shoes and make the foot side fit the foot smoothly, it is preferred that the inner layer of the shoe inner sleeve is made of microfiber material. Here, the microfiber material has good wear resistance and smooth effect, which is used to make the foot not stick when wear and the foot is easy to wear into the shoes; when the foot perspires due to sports, the foot will not stick with the shoe inner layer.

In order to fix the foot better, it is preferred that the upper part of the shoe inner sleeve is provided with a fastening structure, and the fastening structure is provided with an eyelet set for wearing shoelaces, or a fixed Velcro kit. For better fixation, the outer side of the plastic shoe shell is also provided with a leather material with a zipper at the position of the shoe tongue mouth.

In order to avoid excessive stress during skating to damage the shoe sleeve, improve the service life of the product, and improve the adhesion performance of integrated molding, PU or long fiber materials have good adhesion with plastic materials, it is preferred that the outer layer of the shoe inner sleeve includes the reinforcing structure hot pressed at the parts connected with the fastening structure and the plastic shoe shell, respectively. In order to enhance the tensile strength, preferably, the reinforcing structure is PU or long fiber material arranged outside the shoe inner sleeve.

In order to realize the installation of different styles of ice skate blade assembly and roller slide assembly on the bottom of integrated plastic shell with the same yard, as well as the change of installation position and mode, according to the different shoe rack assembly, the shoes can be assembled into integrated ice skates or integrated roller skates, preferably, the shoe rack assembly is a roller slide frame and a roller set mounted on the roller slide frame, or the ice skate blade assembly. In this way, the skates can meet the different occasions of skating and roller skating according to the needs.

Generally speaking, the insert refers to the structural member of the mold structure, and the base piece refers to the structural member of aluminum, iron and other materials used to connect the roller slide frame and ice skate blade which is injected molding from the plastic shoe shell. In order to achieve multiple styles in one mold, preferably, the integrated plastic shell skate also includes a plurality of base pieces matched with a sole position of the plastic shoe shell, the shoe shell mold is provided with a plurality of detachable inserts matched with the base pieces correspondingly. The inserts at the sole position on the shoe shell mold are replaceable, and the base pieces are integrated with the plastic shoe shell by the injection molding through the matched inserts on the shoe shell mold. In this way, the plastic shoe shell can respectively produce the roller skates with the roller slide assembly and the ice skates with the ice skate blade assembly in the same mold by replacing only the detachable inserts at the sole part of the mold. That is to say, by using the plastic shoe shell produced by the shoe shell mold with the same size and changing the detachable inserts at the sole position of the plastic shoe mold, the different styles of skates with different base piece and different positions are realized, so as to realize multiple styles in one mold. Namely, the integrated plastic shell ice skates can be produced, and the integrated plastic shell roller skates can also be produced, so as to save the plastic mold processing time, reduce the cost and reduce the waste of resources.

In order to further enhance the beauty, comfort and use experience, it is preferred that the outer side of the plastic shoe shell is pasted with a leather.

Compared with the available technologies, the integrated plastic shell skates provided by the present disclosure have the advantageous effect as follows: Through the new technology that the shoe inner sleeve and the plastic shoe shell are injected into a whole, and the shoe inner sleeve is formed by one-step pressing in the inner sleeve cold pressing die after the pre-heating process; by replacing the detachable insert on the shoe sole of the plastic shoe shell mold, the production of ice skates and roller skates in various styles and the same mold are achieved; the inner sleeve of shoes is without seam stitching, and the shoe inner sleeve and the shoe shell are not glued, which fit the foot surface more; and it has the characteristics of light, comfortable, safe, environmental protection, strong and durable. The process greatly reduces the production cost, improves the quality and efficiency, and is conducive to the protection of the staffs body and environment.

### BRIEF DESCRIPTION OF THE DRAWINGS

FIG. 1 is an overall top view structural diagram of the first embodiment of the present disclosure;

FIG. 2 is an overall front view structural diagram of the first embodiment of the present disclosure;

FIG. 3 is a top view structural diagram of the shoe inner sleeve in the first embodiment of the present disclosure;

FIG. 4 is a lateral view structural diagram of the shoe inner sleeve in the first embodiment of the present disclosure;

FIG. 5 is a top view structural diagram of the shoe shell in the first embodiment of the present disclosure;

FIG. 6 is a lateral view structural diagram of the shoe shell in the first embodiment of the present disclosure;

FIG. 7 is an overall front view structural diagram of the second embodiment of the present disclosure;

FIG. 8 is a top view structural diagram of the second embodiment of the present disclosure.

In the drawings: 1—Shoe inner sleeve, 2—Plastic shoe shell, 3—Reinforcing structure, 4.—Roller slide frame, 5.—Roller set, 6—Ice skate blade.

### DETAILED DESCRIPTION OF THE EMBODIMENT

The technical solutions in the embodiments of the present disclosure will be described clearly and completely in combination with the drawings. Apparently, the described embodiments are only part of the embodiments of the present disclosure, not all of them. Based on the embodiments in the present disclosure, all other embodiments obtained by ordinary skilled person in the art without making creative labour belong to the protection scope of the present disclosure.

### Embodiment 1

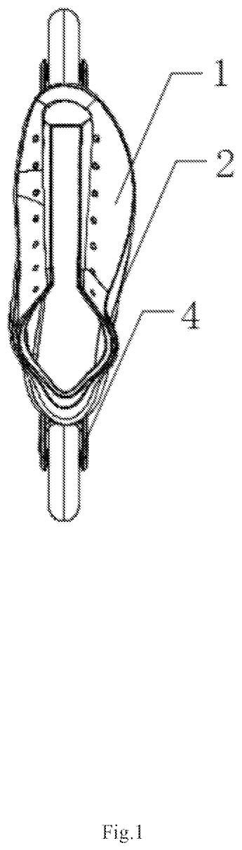

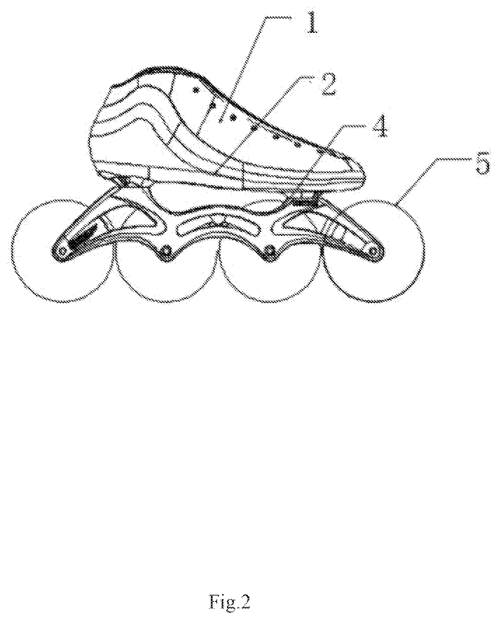

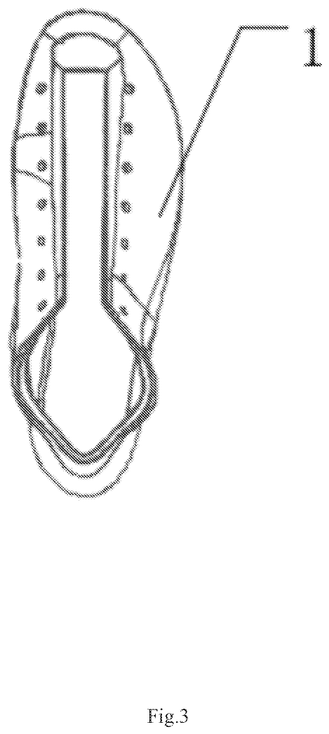

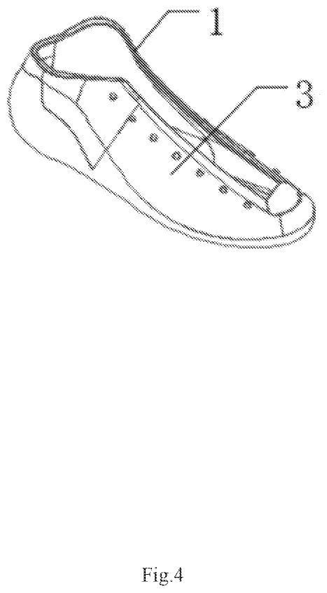

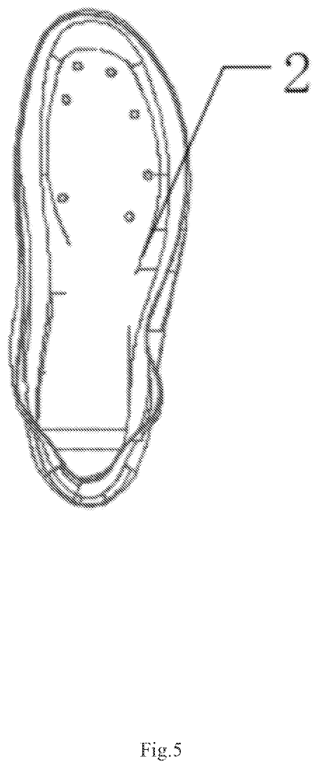

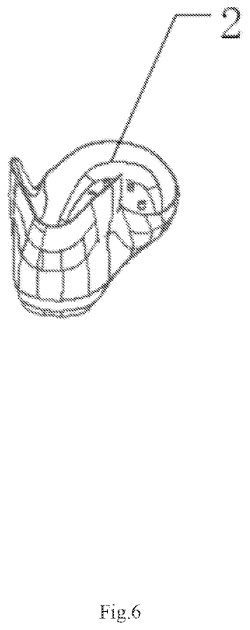

As shown in FIG. 1-FIG. 6, an integrated plastic shell roller skate includes a shoe inner sleeve 1, a plastic shoe shell 2, and a shoe rack assembly. The shoe rack assembly is fixedly installed on the bottom of the plastic shoe shell 2. The shoe inner sleeve 1 is one-step formed in the inner mold, and the plastic shoe shell 2 is one-step formed at the outer side of the shoe inner sleeve 1 through the shoe shell mold, so that the plastic shoe shell 2 and the shoe inner sleeve 1 are formed as a whole. The manufacturing process is as follows: the shoe inner sleeve 1 is put on the inner mold cavity of the shoe shell mold after the forming of the shoe inner sleeve 1 is completed; the plastic shoe shell 2 is one-step formed on the outer side of the shoe inner sleeve 1 by the injection molding of the shoe shell mold, so that the inner surface of the plastic shoe shell 2 and the outer surface of the shoe inner sleeve 1 are closely combined and integrated into one body.

The shoe inner sleeve 1 is formed into the shape and size of the shoe inner sleeve 1 by one-step pressing in the inner sleeve mold with a cut-piece composite material, including an inner layer, an intermediate layer and an outer layer, and the intermediate layer is made of EVA material.

The shoe inner sleeve 1 is provided with a positioning structure matched with the inner mold cavity of the shoe shell mold, the positioning structure is an eyelet of the shoe inner sleeve 1, and the shoe shell mold is provided with a small cylinder correspondingly, and the eyelet is sleeved and hung on the small cylinder. Convex and concave parts of the shoe inner sleeve 1 covered from the rear end of the ankle heel part to the front end of the instep are matched with the inner mold cavity of the shoe shell mold to form an inverted buckle. Here, the shoe inner sleeve 1 has a certain elasticity, and the matching design of the eyelet and the shoe shell mold for anti-displacement can effectively ensure that the shoe inner sleeve is not displaced. In addition, the matching inverted buckle clamps the shoe inner sleeve 1 on the inner mold cavity of the shoe shell mold, preventing the shoe inner sleeve from sliding out and loosening.

The outer side of the shoe edge part of the shoe inner sleeve 1 is made of hard EVA material, and the inner foot sticking part is made of soft EVA material. The shoe inner sleeve 1 is pressed once in the inner sleeve cold pressing die after pre-heating. The inner layer of the shoe inner sleeve 1 is made of microfiber material.

The upper part of the shoe inner sleeve 1 is provided with a fastening structure, and the fastening structure is provided with an eyelet set for wearing shoelaces, or a fixed Velcro kit. The outer side of the plastic shoe shell 2 is further provided with a leather material with a zipper at the position of the shoe tongue mouth.

The outer layer of the shoe inner sleeve 1 includes the reinforcing structure 3 hot pressed at the parts connected with the fastening structure and the plastic shoe shell 2, respectively. The reinforcing structure 3 is PU or long fiber material arranged outside the shoe inner sleeve 1.

The shoe rack component is a roller slide frame 4 and a roller set 5 mounted on roller slide frame, and the roller set 5 includes a plurality of rollers. By using the plastic shoe shell produced by the shoe shell mold with the same size and changing the detachable inserts at the sole position of the plastic shoe mold, the different styles of skates with different base piece and different positions are realized, so as to realize multiple styles in one mold. Namely, the integrated plastic shell ice skates can be produced, and the integrated plastic shell roller skates can also be produced.

The outer side of the plastic shoe shell 2 is pasted with a leather.

### Embodiment 2

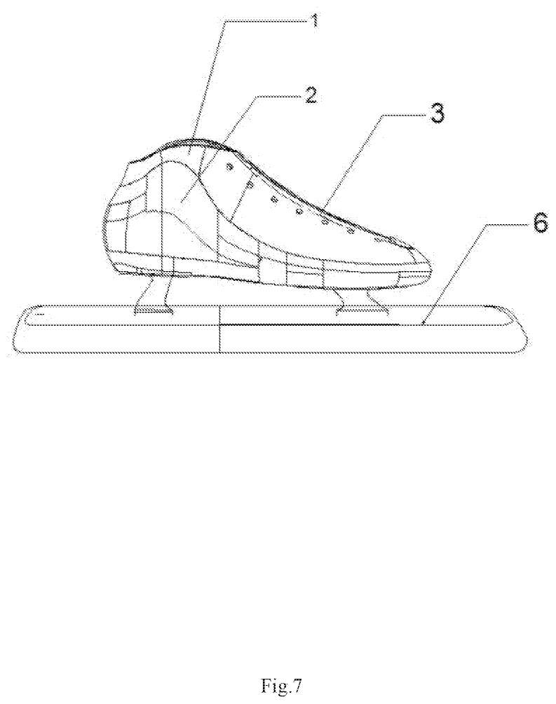

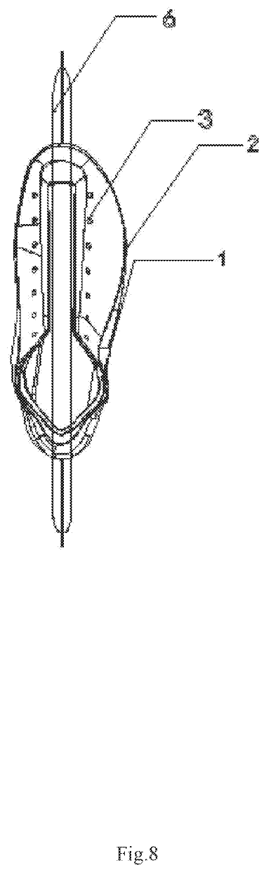

As shown in FIG. 7-FIG. 8, this embodiment is different from embodiment 1 in that it is an integrated plastic shoe shell ice skate, and the shoe rack component is the ice skate blade rack and the ice skate blade 6 installed on it. The bottom of the plastic shoe shell can be assembled into various styles of integrated ice skate shoes by installing different types of the ice skate blade 6 and changing the installation position and method.

Although the embodiments of the present disclosure have been shown and described, it can be understood to those skilled in the art that a variety of changes, modifications, substitutions and variants can be made to these embodiments without departing from the principle and spirit of the present disclosure, and the scope of the present disclosure is defined by the appended claims and their equivalents.

What is claimed is:

1. An integrated plastic shell skate, comprising a shoe inner sleeve, a plastic shoe shell and a shoe rack assembly, the shoe rack assembly is fixedly installed at a bottom of the plastic shoe shell; the shoe inner sleeve is one-step formed by pressing once in an inner sleeve mold, and the plastic shoe shell is one-step formed by injecting once at an outer side of the shoe inner sleeve through a shoe shell mold, so that the plastic shoe shell and the shoe inner sleeve are integrated formed as a whole, a manufacturing process is as follows: the shoe inner sleeve is put on an inner mold cavity of the shoe shell mold after the forming of the shoe inner sleeve is completed; the plastic shoe shell is one-step formed on the outer side of the shoe inner sleeve by injection molding of the shoe shell mold, so that an inner surface of the plastic shoe shell and an outer surface of the shoe inner sleeve are closely combined and integrated into a whole.

2. The integrated plastic shell skate according to claim 1, wherein the shoe inner sleeve is formed by pre-heating of the cut-piece composite material, and then cold pressing into the shape and size of the shoe inner sleeve in the inner sleeve cold pressing die, comprising an inner layer, an intermediate layer and an outer layer, and the an intermediate layer is made of EVA or elastic material with a certain elasticity.

3. The integrated plastic shell skate according to claim 2, wherein the shoe inner sleeve is provided with a positioning structure matched with the inner mold cavity of the shoe shell mold, the positioning structure is an eyelet of the shoe inner sleeve, and the shoe shell mold is provided with a small cylinder correspondingly, and the eyelet is sleeved and hung on the small cylinder; convex and concave parts of the shoe inner sleeve covered from a rear end of the ankle heel part to a front end of the instep are matched with the inner mold cavity of the shoe shell mold to form an inverted buckle, and the shoe inner sleeve is buckled by the inverted buckle and a motion of the shoe inner sleeve is limited.

4. The integrated plastic shell skate according to claim 2, wherein the outer side of the shoe edge part of the shoe inner sleeve is made of hard EVA material, and the inner foot sticking part is made of soft EVA material.

5. The integrated plastic shell skate according to claim 3, wherein the inner layer of the shoe inner sleeve is made of microfiber material.

6. The integrated plastic shell skate according to claim 3, wherein the upper part of the shoe inner sleeve is provided with a fastening structure, and the fastening structure is provided with an eyelet set for wearing shoelaces, or a fixed Velcro kit.

7. The integrated plastic shell skate according to claim 6, wherein the outer side of the plastic shoe shell is also provided with a leather material with a zipper at the position of the shoe tongue mouth.

8. The integrated plastic shell skate according to claim 7, wherein the outer layer of the shoe inner sleeve comprises the reinforcing structure hot pressed at the parts connected with the fastening structure and the plastic shoe shell, respectively.

9. The integrated plastic shell skate according to claim 8, wherein the reinforcing structure is PU or long fiber material arranged outside the shoe inner sleeve.

10. The integrated plastic shell skate according to claim 3, wherein the shoe rack assembly is a roller slide frame and a roller set mounted on the roller slide frame, or an ice skate blade assembly; the integrated plastic shell skate also comprises a plurality of base pieces matched with a sole position of the plastic shoe shell, the shoe shell mold is provided with a plurality of detachable inserts matched with the base pieces correspondingly, the inserts at the sole position on the shoe shell mold are replaceable, and the base pieces are integrated with the plastic shoe shell by injecting molding through the matched inserts on the shoe shell mold; an upper portion of the outer side of the plastic shoe shell is pasted with a leather.

11. The integrated plastic shell skate according to claim 3, wherein the outer side of the shoe edge part of the shoe inner sleeve is made of hard EVA material, and the inner foot sticking part is made of soft EVA material.
